(19) United States
(12) Patent Application Publication
(10) Pub. No.: US 2011/0262266 A1
(43) Pub. Date: Oct. 27, 2011

(54) Linear Actuator for a Variable-Geometry Member of a Turbocharger, and a Turbocharger Incorporating Same

(75) Inventor: Matus Rakoci, Brno (CZ)

(73) Assignee: Honeywell International Inc.

(21) Appl. No.: 12/766,200

(22) Filed: Apr. 23, 2010

(51) Int. Cl. F02B 33/40; F04D 29/46

(52) U.S. Cl. 415/118; 415/159

(57) ABSTRACT

A linear actuator for a variable-geometry member of a turbocharger comprises a fixed portion and a movable portion that can undergo primary translational movement along a longitudinal axis and secondary rotational movement about one or more other axes. A sensor assembly is included, comprising a permanent magnet fixedly mounted on the movable portion and a sensor fixedly mounted relative to the fixed portion and adjacent to the magnet. The sensor is operable to sense magnetic flux density components of the magnet along each of three mutually orthogonal axes. A position of the magnet along the longitudinal axis is determinable from these magnetic flux density components.

### BACKGROUND OF THE INVENTION

The present disclosure relates to exhaust gas-driven turbochargers having a variable-geometry member for regulating the flow of exhaust gas through the turbine. The disclosure relates in particular to a linear actuator for effecting movement of the variable-geometry member.

Turbochargers for internal combustion engines often include some type of variable-geometry member for regulating exhaust gas flow through the turbine so as to provide a greater degree of control over the amount of boost provided to the engine by the turbocharger. Such variable-geometry members can include variable vane arrangements, waste gates, sliding pistons, etc.

Linear actuators are frequently employed for providing the motive force to move the variable-geometry member of the turbocharger. An actuator rod or shaft of the actuator is mechanically coupled to the variable-geometry member. Examples of such linear actuators include pneumatic actuators operated by vacuum derived from the engine's intake system.

In order to accurately control the position of the variable-geometry member, typically a sensor assembly is incorporated in the linear actuator for sensing the position of the actuator rod along the nominal displacement path of the actuator rod. One type of sensor assembly comprises a permanent magnet and a Hall effects sensor. The magnet is housed within the movable part of the actuator that imparts movement to the actuator rod. The sensor is disposed in the fixed part of the actuator, proximate the magnet. The nominal displacement path of the actuator rod is usually coincident with the longitudinal axis of the actuator rod. However, often the actual movement of the actuator rod is not a pure translation along the longitudinal axis of the rod, but also includes some amount of rotation of the rod about one or more axes that are not parallel to the longitudinal axis. This complex movement of the actuator rod complicates the accurate sensing of the actuator rod position by the sensor assembly.

Others have tried to address this problem by providing a guiding structure for the actuator rod. The guiding structure surrounds and contacts the actuator rod and constrains it to pivot about a fixed pivot point that is proximate the sensor. The magnet is contained in a part of the rod adjacent the sensor. The objective of this arrangement is to keep the radial spacing between the magnet and the sensor constant regardless of whether the rod is purely translating or undergoing a complex translation and rotation movement. One drawback of this approach is that the guiding structure exerts frictional forces on the actuator rod as it slides, and therefore the actuator force must overcome the frictional force before the rod will move. The sliding contact between the guiding structure and the actuator rod also causes wear of these surfaces, which in turn leads to increasing “slop” over time, so the guiding structure gradually loses its effectiveness at keeping the magnet-to-sensor spacing constant.

### BRIEF SUMMARY OF THE DISCLOSURE

The present disclosure concerns a linear actuator for a variable-geometry member of a turbocharger. The linear actuator includes a sensor assembly whose accuracy does not depend on keeping the magnet-to-sensor spacing constant. Accordingly, the sensor assembly is able to cope with complex movements of the actuator rod (or, more generally, the movable portion of the actuator) without impairment to the accuracy of position detection. Furthermore, the actuator does not require any guiding structure that contacts the part that houses the magnet, so friction and wear are eliminated or at least substantially reduced.

In accordance with one embodiment described herein, a turbocharger for an internal combustion engine comprises a compressor wheel and a turbine wheel mounted on a common shaft, the compressor wheel being disposed in a compressor housing and the turbine wheel being disposed in a turbine housing, the turbine housing defining passages for receiving exhaust gas, directing the exhaust gas to the turbine wheel, and discharging the exhaust gas from the turbine housing. The turbocharger further includes a variable-geometry member operable to regulate flow of exhaust gas through the turbine housing, and a linear actuator coupled with the variable-geometry member and operable to cause movement of the variable-geometry member.

The linear actuator comprises a fixed portion and a movable portion, the movable portion being coupled with the fixed portion by a coupling arrangement that permits the movable portion to undergo generally linear movement relative to the fixed portion in a direction generally parallel to a longitudinal axis so as to cause movement of the variable-geometry member. The coupling arrangement also permits the movable portion to undergo rotational movement, within limits set by the coupling arrangement, about at least one axis that is non-parallel to the longitudinal axis. The actuator includes a sensor assembly comprising a permanent magnet fixedly mounted on the movable portion and a sensor fixedly mounted relative to the fixed portion and adjacent to the magnet. The generally linear and rotational movements of the movable portion cause movement of the magnet relative to the sensor, and that movement of the magnet has components along at least two orthogonal axes.

The sensor is operable to sense magnetic flux density components of the magnet along multiple orthogonal axes. A position of the magnet along the longitudinal axis is determinable from these magnetic flux density components.

In a particular embodiment described herein, the sensor assembly includes a magnet carrier that defines an internal cavity in which the magnet is disposed. The sensor assembly also includes a sensor housing that defines an internal cavity in which the sensor is disposed. The coupling arrangement of the actuator is configured to allow the generally linear and rotational movements of the movable portion while preventing contact between the outer surface of the magnet carrier and the outer surface of the sensor housing. Thus, during normal operation, there is always space between the outer surfaces of the magnet carrier and the sensor housing, so friction and wear of these surfaces are eliminated.

More generally, the actuator is free of any guiding structure that would contact the outer surface of the magnet carrier to guide movement thereof as the movable portion undergoes the generally linear and rotational movements.

In the embodiment described herein, the fixed portion of the actuator comprises an enclosure, and the movable portion of the actuator includes a diaphragm within the enclosure, the enclosure and diaphragm cooperating to define an interior chamber capable of supporting a fluid pressure differential across the diaphragm. The actuator further comprises a spring biasing the diaphragm in a direction opposite the fluid pressure differential across the diaphragm, whereby in the absence of such a fluid pressure differential the spring biases the diaphragm against a first stop defining a first extreme position of the movable portion.

In the described embodiment of the actuator, the portion of the sensor housing in which the sensor is contained extends into the interior chamber and is offset to one side of the longitudinal axis, and the magnet is located on the longitudinal axis.

The sensor can comprise a multi-axis Hall effects sensor.

In the described embodiment, the magnet carrier includes a hollow generally cylindrical portion in which the magnet is disposed, the generally cylindrical portion having a proximal end proximate the sensor and an opposite distal end remote from the sensor, the magnet carrier further including a generally disk-shaped portion joined to the distal end of the generally cylindrical portion.

The spring in the described embodiment comprises a coil spring disposed generally concentrically about the magnet carrier, and the generally disk-shaped portion of the magnet carrier defines a surface contacted by one end of the coil spring.

The magnet carrier can include a plastic portion and a metal portion, the plastic portion including the generally cylindrical portion that houses the magnet, the metal portion defining the surface contacted by the coil spring.

The movable portion of the actuator can include a generally cup-shaped member having an open end located relatively closer to the sensor and a closed end defined by a bottom wall located relatively farther from the sensor. The disk-shaped portion of the magnet carrier contacts an inner surface of the bottom wall of the generally cup-shaped member.

### BRIEF DESCRIPTION OF THE SEVERAL VIEWS OF THE DRAWING(S)

Having thus described the disclosure in general terms, reference will now be made to the accompanying drawings, which are not necessarily drawn to scale, and wherein:

FIG. 1 is a cross-sectional view of a turbocharger and actuator in accordance with one embodiment of the invention;

FIG. 2 is a cross-sectional view of an actuator in accordance with one embodiment of the invention;

FIG. 3 is a side view of a sensor assembly for the actuator, in accordance with one embodiment of the invention;

FIG. 4 is a cross-sectional view through the sensor assembly, along line 4-4 in FIG. 3;

FIG. 5 is a cross-sectional view of the actuator in a fully extended position;

FIG. 6 is a cross-sectional view of the actuator in a retracted position; and

FIG. 7 is a cross-sectional view of the actuator in an intermediate position, where the actuator rod has both translated and rotated.

### DETAILED DESCRIPTION OF THE DRAWINGS

The turbocharger and actuator now will be described more fully hereinafter with reference to the accompanying drawings in which some but not all possible embodiments are shown. Indeed, the turbocharger and actuator may be embodied in many different forms and should not be construed as limited to the embodiments set forth herein; rather, these embodiments are provided so that this disclosure will satisfy applicable legal requirements. Like numbers refer to like elements throughout.

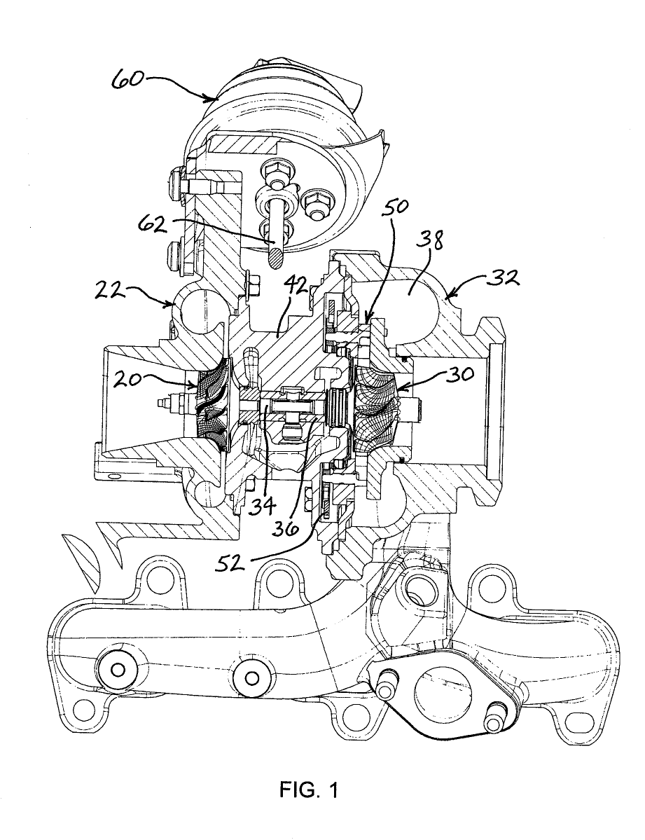

A turbocharger and actuator according to one embodiment are depicted in FIG. 1. The turbocharger comprises a compressor wheel 20 mounted in a compressor housing 22 and a turbine wheel 30 mounted in a turbine housing 32. The compressor wheel and turbine wheel are mounted on opposite ends of a shaft 34 that is supported in bearings 36 mounted in a center housing 42. The compressor housing 22 is fastened to one side of the center housing 42 and the turbine housing 32 is fastened to the other side of the center housing. Exhaust gas from an engine is fed into an inlet in the turbine housing, into a volute 38 that surrounds the turbine wheel 30. The exhaust gas is fed from the volute 38 into the turbine wheel 30 through a variable nozzle 50. In the illustrated embodiment, the variable nozzle 50 includes variable vanes whose setting angles can be varied via rotation of a unison ring 52 about its axis, which axis substantially coincides with the rotation axis of the turbine wheel 30.

The unison ring 52 is rotated by a mechanical linkage (not visible in FIG. 1) that is operated by a linear actuator 60. The actuator 60 includes an actuator rod 62 that projects out from the actuator and is coupled with the mechanical linkage in suitable fashion. The details of coupling the actuator to the variable-geometry member of the turbine will vary from turbocharger to turbocharger, depending on the particular design of the turbocharger and its variable-geometry member. This is well understood by persons of ordinary skill in the turbocharger art, and hence need not be described in detail here.

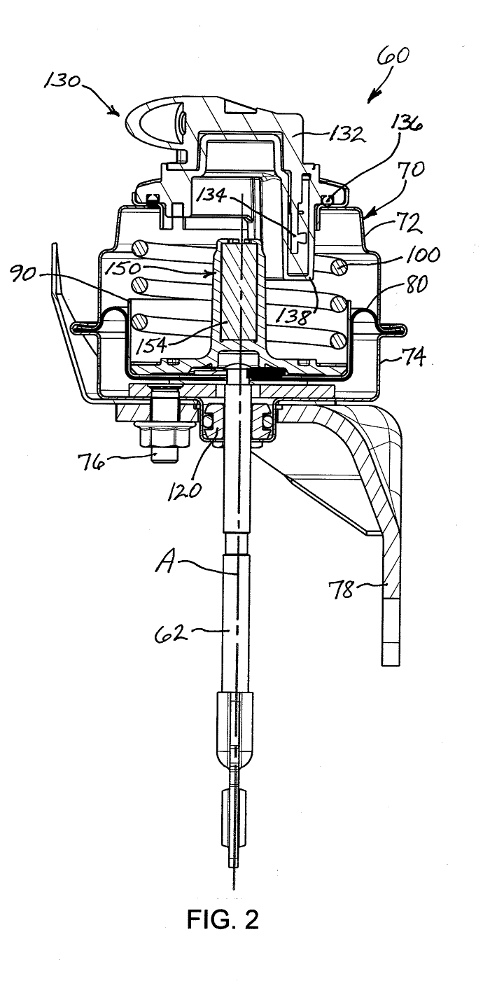

The present disclosure concerns in particular the design of the actuator 60, and therefore the present description will focus on the actuator. FIG. 2 shows a cross-sectional view of the actuator 60 in accordance with one embodiment. Broadly, the actuator comprises a fixed portion that includes an enclosure or housing 70, and a movable portion that includes a diaphragm 80, a cup-shaped member 90, a coil spring 100, and the actuator rod 62. The housing 70 is made up of two generally cup-shaped parts 72 and 74 that are connected to each other, open end-to-open end, so as to form an enclosure. The diaphragm 80 is a sheet of flexible and resilient material that is fluid-impervious, such as a rubber or rubber-like material. An outer periphery of the diaphragm is captured between the two housing parts 72 and 74 in a fluid-sealed manner, such that the diaphragm divides the interior of the housing into an upper chamber and a lower chamber (with respect to the orientation shown in FIG. 2). The upper chamber is sealed with respect to atmosphere, while the lower chamber is vented to atmosphere. The housing 70 is attached, such as by bolts 76, to a bracket 78 that in turn is attached by bolts to a flange formed on the compressor housing 22.

The cup-shaped member 90 of the actuator is disposed with its closed bottom wall against the upper surface of the diaphragm 80 and its open end facing upwardly. The coil spring 100 is disposed substantially concentrically with respect to the cup-shaped member 90 and has one end engaged against the bottom wall of the cup-shaped member 90 and its opposite end engaged against an inner surface of the upper housing part 72 (although the turn of the coil spring that engages the housing part 72 cannot be seen in the cross-section of FIG. 2).

The actuator includes a fluid passage (not visible in FIG. 2) that extends into the upper chamber of the housing 70, through which fluid (typically air) can be evacuated from or fed into the upper chamber. When a vacuum is exerted through the fluid passage, the upper chamber is partially evacuated to create a vacuum in the upper chamber. Because the lower chamber on the other side of the diaphragm 80 is vented to atmosphere, a fluid pressure differential exists across the diaphragm, urging it and the cup-shaped member 90 upwardly so as to compress the spring 100. The position the cup-shaped member 90 moves to depends on the degree of vacuum relative to the spring force. The actuator rod 62 has one end connected to the cup-shaped member 90 and hence it moves along with the cup-shaped member. The other end of the rod 62 is coupled to the variable-geometry member of the turbine, such that linear movement of the rod 62 in one direction or the other (as regulated by the amount of vacuum exerted on the actuator chamber) results in movement of the variable-geometry member.

The actuator rod 62 passes through a ring-shaped gimbal 120 that keeps the portion of the rod within the gimbal generally centered relative to the actuator housing but permits the rod to undergo some degree of pivoting about axes transverse to the longitudinal axis of the rod. This pivoting ability is necessary because as a result of the characteristics of the variable-geometry mechanism to which the distal end of the rod 62 is connected, the rod 62 in some turbochargers will not purely translate parallel to its longitudinal axis, but will undergo a complex motion made up primarily of a translation component parallel to the longitudinal axis but also including a secondary rotation component about at least one axis that is not parallel to the longitudinal axis of the rod. This complex motion of the actuator rod 62 is also imparted to the cup-shaped member 90 because of the substantially rigid connection therebetween. This in turn complicates the accurate sensing of the actuator position, as further described below.

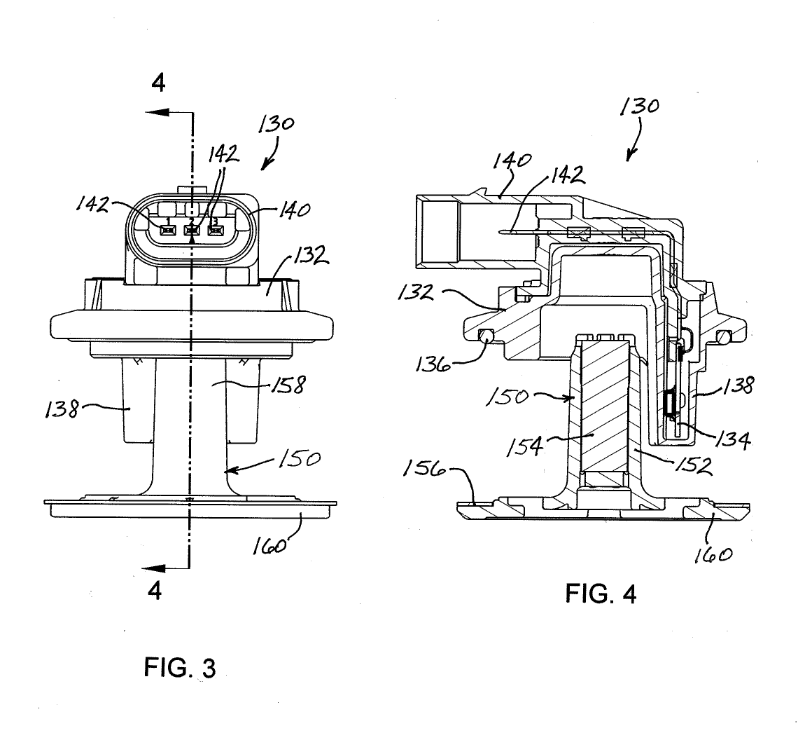

The actuator 60 also includes a sensor assembly 130 for sensing the position of the actuator rod 62 along the nominal longitudinal axis A of the actuator (FIG. 2). The sensor assembly 130 is shown in isolation in FIGS. 3 and 4, and includes a sensor housing 132 containing a sensor 134, and a magnet carrier 150 that houses a permanent magnet 154. As best seen in FIG. 2, the upper housing part 72 of the actuator housing is formed to have a large opening at its upper end, and the sensor housing 132 essentially forms a closure or cap that engages the upper housing part 72 with an O-ring 136 compressed therebetween, so as to sealingly close the opening in the upper housing part 72. A portion 138 of the sensor housing extends through the opening in the upper housing part 72, into the upper chamber of the actuator. The portion 138 of the sensor housing is offset to one side of the longitudinal axis A along which the actuator rod 62 nominally extends. The sensor 134 is contained in this portion 138 of the sensor housing.

The sensor housing 132 includes a socket portion 140 for receiving a plug (not shown). The socket portion 140 houses three electrically conductive pins 142 that are electrically connected to the sensor 134. The plug includes three receptacles that respectively receive the three pins 142, and conductors of the plug carry signals on the pins to a processor (e.g., the vehicle ECU, not shown) that processes the signals to determine the actuator position from the signals.

The magnet carrier 150 comprises a plastic portion 152 and a metal portion 156. The plastic portion 152 includes a hollow generally cylindrical portion 158 that contains the permanent magnet 154, which has a solid generally cylindrical configuration. The magnetic pole of the permanent magnet is substantially coincident with the central longitudinal axis of the cylindrical portion 158 of the magnet carrier. The plastic portion 152 also includes a generally disk-shaped portion 160 joined to the distal (lower) end of the generally cylindrical portion 158. The metal portion 156 of the magnet carrier sits atop the upper surface of the disk-shaped portion 160, and comprises a generally annular member such as a metal washer, the purpose of which will become apparent below.

When the sensor assembly 130 is installed in the actuator 60 as shown in FIG. 2, the permanent magnet 154 has its pole substantially collinear with the longitudinal axis of the actuator rod 62. In the ideal or nominal position of the actuator shown in FIG. 2, the outer surface of the magnet carrier 150 is spaced from the outer surface of the portion 138 of the sensor housing 132. The coil spring 100 has its upper end engaged against the upper end of the housing part 72 and its lower end engaged against the metal portion 156 of the magnet carrier 150 (although the lower turn of the spring that engages the metal portion cannot be seen in the cross-section of FIG. 2). The metal portion 156 forms a more-durable and wear-resistant surface than the plastic disk-shaped portion for engaging the metal coil spring.

The sensor 134 can comprise a multi-axis Hall effects sensor. A suitable sensor, for example, is available from Melexis N. V. of Belgium, as part number MLX90333, although the invention is not limited to any particular model or type of sensor. The sensor is operable to detect components of magnetic flux density of the magnet 154 along at least two mutually orthogonal axes. For example, when the sensor comprises a generally planar chip comprising a multi-axis Hall effects sensor, the flux density in a direction normal to the plane of the chip (i.e., along a Z-axis) can be denoted Bz, and the flux density components along the two mutually orthogonal X- and Y-axes in the plane of the chip can be denoted Bx and By. The sensor can be operable to measure these flux density components and to output two signals that are respectively representative of the Bx and By flux density components. The sensor can be arranged in the actuator such that one of the X- and Y-axes is substantially parallel to the nominal longitudinal axis A (which lies in the plane 4-4 indicated in FIG. 3) along which the actuator rod 62 nominally translates, and such that the other of the X- and Y-axes is perpendicular to the plane 4-4 indicated in FIG. 3 (and hence the Z-axis is perpendicular to the nominal longitudinal axis A). These axes orientations are merely exemplary, not essential. The sensor 134 can be calibrated to work with any orientation of the orthogonal axes. However, greater accuracy of position measurement along the nominal longitudinal axis A is facilitated by aligning the sensor's X- or Y-axis parallel to the nominal longitudinal axis A of the actuator. With appropriate processing of the two signals output from the sensor, the 3D position of the magnet 154 relative to the sensor can be deduced, which in turn allows the position of the actuator rod 62 to be determined.

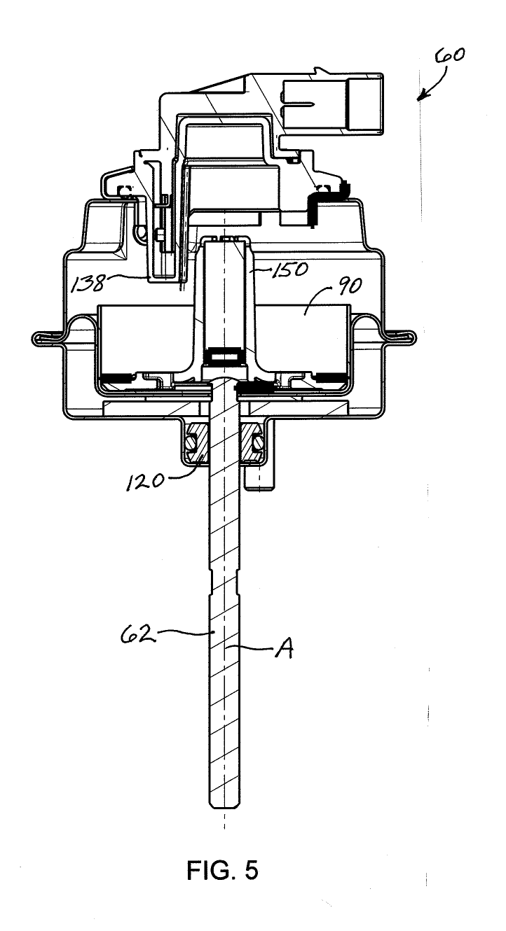

FIGS. 5, 6, and 7 illustrate various actuator positions; certain details of the actuator have been omitted for clarity. FIG. 5 represents a “nominal” fully extended position of the actuator wherein the axis of the actuator rod 62 coincides with the nominal longitudinal axis A of the actuator. There is no contact between the magnet carrier 150 and the sensor housing portion 138.

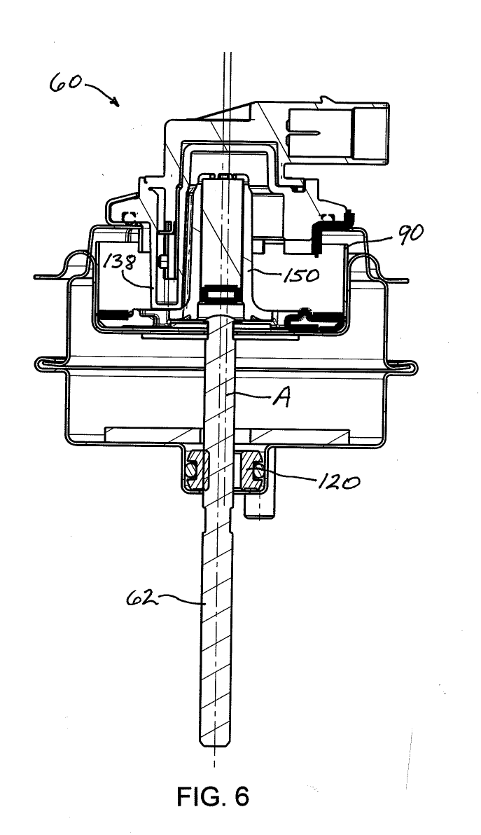

FIG. 6 represents a fully retracted position of the actuator, wherein the axis of the actuator rod 62 is parallel to but offset from the nominal longitudinal axis A by a maximum allowable offset distance. In this offset position, there is still no interference between the magnet carrier 150 and the sensor housing portion 138.

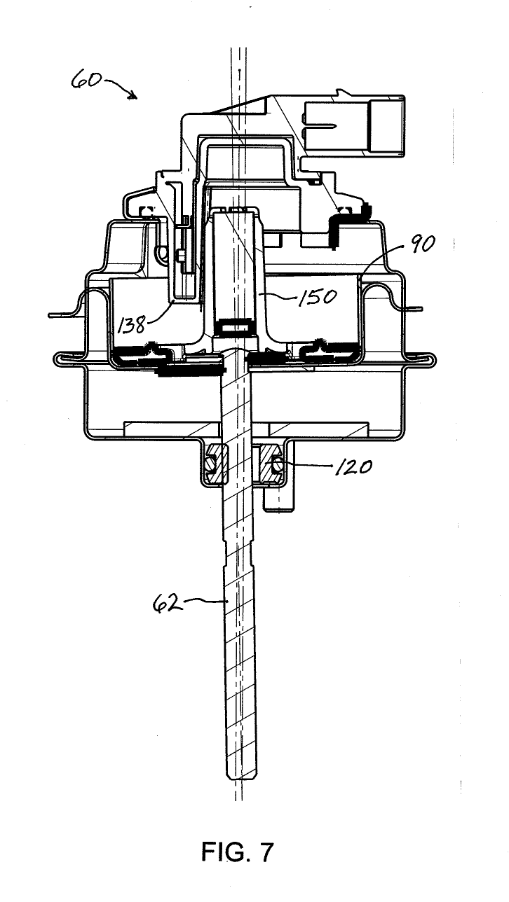

FIG. 7 represents an intermediate position of the actuator, wherein the axis of the actuator rod 62 is both offset from and inclined relative to the nominal longitudinal axis A. The offset and inclination are maximum allowable amounts for this intermediate position, such that there is no interference between the magnet carrier 150 and the sensor housing portion 138.

It can be seen that the member 90 and the magnet carrier 150 move in a substantially unguided manner, in the sense that there is no structure that contacts the outer surface of the magnet carrier 150 to try to keep it at a constant radial spacing distance from the sensor 134. The magnet carrier 150 and actuator rod 62 are free to undergo complex translational-rotational movements, within limits dictated by the coupling arrangement (which includes the gimbal 120) that couples the movable portion with the fixed portion of the actuator. This is possible because of the use of the multi-axis sensor 134 that is capable of detecting and accounting for such complex movements of the magnet 154. It would not be possible with the single-axis types of Hall effects sensors that are commonly employed in linear actuators.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A turbocharger having a variable-geometry mechanism, the turbocharger comprising:
a compressor wheel and a turbine wheel mounted on a common shaft, the compressor wheel being disposed in a compressor housing and the turbine wheel being disposed in a turbine housing, the turbine housing defining passages for receiving exhaust gas, directing the exhaust gas to the turbine wheel, and discharging the exhaust gas from the turbine housing;
a variable-geometry member operable to regulate flow of exhaust gas through the turbine housing; and
a linear actuator coupled with the variable-geometry member and operable to cause movement of the variable-geometry member, the linear actuator comprising:
a fixed portion and a movable portion, the movable portion being coupled with the fixed portion by a coupling arrangement that permits the movable portion to undergo generally linear movement relative to the fixed portion in a direction generally parallel to a longitudinal axis so as to cause movement of the variable-geometry member, the coupling arrangement also permitting the movable portion to undergo rotational movement, within limits set by the coupling arrangement, about at least one axis that is non-parallel to the longitudinal axis; and
a sensor assembly comprising a permanent magnet fixedly mounted on the movable portion and a sensor fixedly mounted relative to the fixed portion and adjacent to the magnet, said generally linear and rotational movements of the movable portion causing movement of the magnet relative to the sensor, said movement of the magnet having components along at least two orthogonal axes;
wherein the sensor is operable to sense magnetic flux density components of the magnet along each of said two orthogonal axes, a position of the magnet along the longitudinal axis being determinable from said magnetic flux density components.

2. The turbocharger of claim 1, wherein the sensor assembly includes a magnet carrier that defines an internal cavity in which the magnet is disposed, the magnet carrier having an outer surface.

3. The turbocharger of claim 2, wherein the sensor assembly includes a sensor housing that defines an internal cavity in which the sensor is disposed, the sensor housing having an outer surface.

4. The turbocharger of claim 3, wherein the coupling arrangement of the actuator is configured to allow said generally linear and rotational movements of the movable portion while preventing contact between the outer surface of the magnet carrier and the outer surface of the sensor housing.

5. The turbocharger of claim 3, wherein the actuator is free of any guiding structure that would contact the outer surface of the magnet carrier to guide movement thereof as the movable portion undergoes said generally linear and rotational movements.

6. The turbocharger of claim 5, wherein the fixed portion of the actuator comprises an enclosure, and wherein the movable portion of the actuator includes a diaphragm within the enclosure, the enclosure and diaphragm cooperating to define an interior chamber capable of supporting a fluid pressure differential across the diaphragm, the actuator further comprising a spring biasing the diaphragm in a direction opposite the fluid pressure differential across the diaphragm, whereby in the absence of said fluid pressure differential the spring biases the diaphragm against a first stop defining a first extreme position of the movable portion.

7. The turbocharger of claim 6, wherein a portion of the sensor housing containing the sensor extends into the interior chamber and is offset to one side of the longitudinal axis, and the magnet is located on the longitudinal axis.

8. The turbocharger of claim 1, wherein the sensor comprises a multi-axis Hall effects sensor.

9. An actuator for a variable-geometry member of a turbocharger, comprising:
a fixed portion and a movable portion, the movable portion being coupled with the fixed portion by a coupling arrangement that permits the movable portion to undergo generally linear movement relative to the fixed portion in a direction generally parallel to a longitudinal axis so as to cause movement of the variable-geometry member, the coupling arrangement also permitting the movable portion to undergo rotational movement, within limits set by the coupling arrangement, about at least one axis that is non-parallel to the longitudinal axis; and
a sensor assembly comprising a permanent magnet fixedly mounted on the movable portion and a sensor fixedly mounted relative to the fixed portion and adjacent to the magnet, said generally linear and rotational movements of the movable portion causing movement of the magnet relative to the sensor, said movement of the magnet having components along at least two orthogonal axes;
wherein the sensor is operable to sense magnetic flux density components of the magnet along each of said two orthogonal axes, a position of the magnet along the longitudinal axis being determinable from said magnetic flux density components.

10. The actuator of claim 9, wherein the sensor assembly includes a magnet carrier that defines an internal cavity in which the magnet is disposed, the magnet carrier having an outer surface.

11. The actuator of claim 10, wherein the sensor assembly includes a sensor housing that defines an internal cavity in which the sensor is disposed, the sensor housing having an outer surface.

12. The actuator of claim 11, wherein the coupling arrangement of the actuator is configured to allow said generally linear and rotational movements of the movable portion while preventing contact between the outer surface of the magnet carrier and the outer surface of the sensor housing.

13. The actuator of claim 11, wherein the actuator is free of any guiding structure that would contact the outer surface of the magnet carrier to guide movement thereof as the movable portion undergoes said generally linear and rotational movements.

14. The actuator of claim 13, wherein the fixed portion of the actuator comprises an enclosure, and wherein the movable portion of the actuator includes a diaphragm within the enclosure, the enclosure and diaphragm cooperating to define an interior chamber capable of supporting a fluid pressure differential across the diaphragm, the actuator further comprising a spring biasing the diaphragm in a direction opposite the fluid pressure differential across the diaphragm, whereby in the absence of said fluid pressure differential the spring biases the diaphragm against a first stop defining a first extreme position of the movable portion.

15. The actuator of claim 14, wherein a portion of the sensor housing extends into the interior chamber and is offset to one side of the longitudinal axis, and the magnet is located on the longitudinal axis.

16. The actuator of claim 15, wherein the magnet carrier includes a hollow generally cylindrical portion in which the magnet is disposed, the generally cylindrical portion having a proximal end proximate the sensor and an opposite distal end remote from the sensor, the magnet carrier further including a generally disk-shaped portion joined to the distal end of the generally cylindrical portion.

17. The actuator of claim 16, wherein the spring comprises a coil spring disposed generally concentrically about the magnet carrier, and wherein the generally disk-shaped portion of the magnet carrier defines a surface contacted by one end of the coil spring.

18. The actuator of claim 17, wherein the magnet carrier includes a plastic portion and a metal portion, the plastic portion including the generally cylindrical portion that houses the magnet, the metal portion defining the surface contacted by the coil spring.

19. The actuator of claim 16, wherein the movable portion includes a generally cup-shaped member having an open end located relatively closer to the sensor and a closed end defined by a bottom wall located relatively farther from the sensor, the disk-shaped portion of the magnet carrier contacting an inner surface of the bottom wall of the generally cup-shaped member.

20. The actuator of claim 9, wherein the sensor comprises a multi-axis Hall effects sensor.
